(19) United States
(12) Patent Application Publication
(10) Pub. No.: US 2014/0089193 A1
(43) Pub. Date: Mar. 27, 2014

(54) Replay Engine and Passive Profile/Multiple Model Parallel Scoring

(71) Applicant: Visa International Service Association, San Francisco, CA (US)

(72) Inventors: Benjamin Scott Boding, Mountain View, CA (US); Cory H. Siddens, Mountain View, CA (US)

(73) Assignee: Visa International Service Association, San Francisco, CA (US)

(21) Appl. No.: 13/949,137

(22) Filed: Jul. 23, 2013

Related U.S. Application Data
(60) Provisional application No. 61/704,416, filed on Sep. 21, 2012.

(51) Int. Cl. G06Q 20/38

(52) U.S. Cl. CPC G06Q 20/382
USPC 705/44

(57) ABSTRACT

Systems and methods for testing new profiles and rules against past transaction data in a quick manner are provided. A set of transactions is identified by a merchant based on a selection criterion that is replayed against the new profile. Results of the replay are recorded and compared against the original results obtained from applying an existing profile to the same set of transaction data. A tic-tac-toe report is generated for the merchant showing shifts in transaction results between the existing profile and the new profile. Embodiments of the invention further allow merchants to generate multiple scores, in parallel, against different transaction models using knobs or hedges.

### CROSS-REFERENCES TO RELATED APPLICATIONS

This application is a non-provisional application of and claims the benefit of priority of U.S. Provisional Application No. 61/704,416 filed on Sep. 21, 2012, which is herein incorporated by reference in its entirety for all purposes.

### BACKGROUND

Merchants are continually trying to create fraud detection rules to automatically differentiate fraudulent transactions from non-fraudulent transactions. Since different merchants are in different industries, the fraud rules for these merchants may also differ. Fraudulent activities may be more prevalent in one industry, but may not be prevalent in another.

In a conventional fraud detection system, a set of fraud detection rules may be applied to an incoming transaction to either accept or reject the transaction. In some cases, a transaction that has been accepted may turn out to be fraudulent at a later time and end up as a chargeback. This may result in inefficient use of resources (e.g., computing, monetary and time) for the merchant, consumer, and all the entities involved with processing the transaction (e.g., the acquirer, issuer and the payment processing network).

There is a need for merchants to test different fraud rule profiles to continually improve their fraud detection capabilities. In one system, a merchant may create a passive fraud rule profile that may be simultaneously run with a working, active fraud rule profile. The active fraud rule profile may be applied to transaction data to classify transactions as being accepted, rejected or reviewed. The passive profile may run in the background and data may be collected on how the passive rule profile performs against the transactions. The process of collecting the data over a period of time to determine how the rules in the passive fraud rule profile perform is slow. For example, it may take a month to collect sufficient transaction data to determine how a passive fraud rule profile is performing. It would be desirable to provide for a faster and more convenient way for a merchant to determine if new fraud rule profiles are effective.

Embodiments of the invention address these and other problems, individually and collectively.

### BRIEF SUMMARY

Embodiments of the invention are directed to systems and methods to allow merchants or others to test new fraud rule profiles on past transaction data. New fraud rule profiles can be quickly tested to determine if they are effective. More specifically, embodiments of the invention enable the merchants to select a set of past transactions based on a certain selection criteria. The transactions can be run against new profiles and rules. In some cases, a new profile may be referred to as a “replay profile” since it is a rules profile that is applied against “replayed” transactions. More specifically, a replay engine takes the past transactions data and runs it against the replay profile to generate replay results.

In some cases, replay results are compared against original results to generate a replay report. The original results may be generated as a result of running the past transaction data against an existing profile, i.e., active profile. In one embodiment, the replay report is generated in a tic-tac-toe format to display the shift in transaction results between the existing profile and the replay profile. This particular format makes it easy for a merchant or other end consumer to quickly understand how the replay profile can perform relative to an active profile.

Some embodiments of the invention allow for rescoring using different transaction models with different settings without rerunning the transactions. In one embodiment, a merchant can generate scores in parallel for different types of transaction models, such as, geographic, vertical and/or custom models. In one embodiment, different categories (e.g., phone number, transaction velocity, address, etc.) within a model can be adjusted using “hedges” or “knobs” at the profile level for each transaction. For example, for a transaction relating to a purchase of digital media online, weighting on the shipping address may be tuned to low and weighting on the email address may be tuned to high. This enables the merchant to quickly determine the impact of new rules and profiles for making decisions on using the new rules and profiles for fraud detection in future transactions.

One embodiment of the invention is directed to receiving transaction data for a plurality of transactions, applying, by a server computer, an active profile of rules to the plurality of transactions, after receiving the transaction data and applying the active profile of rules, applying, by the server computer, a replay profile to the plurality of transactions, and generating, by the server computer, a replay profile report as a result of applying the replay profile.

One embodiment of the invention is directed to a server computer comprising a processor, a computer readable medium coupled to the processor, the computer readable medium comprising code, executable by the processor for implementing a method comprising receiving transaction data for a plurality of transactions, applying an active profile of rules to the plurality of transactions, after receiving the transaction data and applying the active profile of rules, applying a replay profile to the plurality of transactions, and generating a replay profile report as a result of applying the replay profile.

Another embodiment of the invention is directed to a method comprising searching for a plurality of transactions, selecting an active profile of rules, selecting a replay profile of rules, scheduling a replay of the plurality of transactions against the replay profile and receiving a replay profile report.

Another embodiment of the invention is directed to a client computer comprising a processor, and a computer readable medium coupled to the processor, the computer readable medium comprising code, executable by the processor for implementing a method comprising searching for a plurality of transactions, selecting an active profile of rules, selecting a replay profile of rules, scheduling a replay of the plurality of transactions against the replay profile and receiving a replay profile report.

These and other embodiments of the invention are described in further detail below.

### BRIEF DESCRIPTION OF THE DRAWINGS

FIG. 1 illustrates an exemplary system with at least some of the elements for using embodiments of the invention.

FIG. 2 illustrates at least some of the elements of a merchant processor server computer in accordance with embodiments of the invention.

FIG. 3 illustrates an exemplary replay system, in one embodiment of the invention.

FIG. 4 illustrates an exemplary process flow, in one embodiment of the invention.

FIG. 5 illustrates a block diagram illustrating an embodiment of the invention for generating multiple scores in parallel against different transaction models.

FIG. 6 illustrates an exemplary screen shot 600 displaying a user interface for selecting a profile.

FIG. 7 illustrates an exemplary screen shot displaying a user interface for selecting past transactions in one embodiment of the invention.

FIG. 8 illustrates an exemplary screen shot displaying a user interface for selecting past transactions based on multiple transaction selection criteria in one embodiment of the invention.

FIG. 9 illustrates an exemplary table displaying an embodiment of the invention for storing at least some components of the transaction data.

FIG. 10 illustrates an exemplary screen shot for a user interface for tuning hedge settings in an embodiment of the invention.

FIG. 11 illustrates an exemplary replay report, in one embodiment of the invention; and

FIG. 12 is a block diagram of a computer apparatus.

### DETAILED DESCRIPTION

A fraud detection system may have a core set of fraud detection rules and merchant profiles specific to the merchants, as further explained in the co-pending U.S. application Ser. No. 13/458,910, entitled “Fraud Detection System User Interface,” by B. Scott Boding and Cory H. Siddens, filed on Apr. 27, 2012, which is herein incorporated by reference in its entirety and which is assigned to the same assignee as the present application. Additionally, new fraud detection rules can be suggested to different merchants based on the past transactions to reduce fraud in future transactions, as discussed in the co-pending U.S. application Ser. No. 13/597,930, entitled “Rules Suggestion Engine” by B. Scott Boding, filed on Aug. 29, 2012, which is herein incorporated by reference in its entirety, and is assigned to the same assignee as the present application.

Systems and methods for quickly testing new profiles and rules against past transaction data are provided. A set of transactions is identified by a merchant based on a selection criterion that is replayed against the new profile. Results of the replay are recorded and compared against the original results obtained from applying an existing active fraud rule profile to the same set of transaction data. A tic-tac-toe type report is generated for the merchant showing shifts in transaction results between the existing profile and the new profile. Embodiments of the invention further allow merchants to generate multiple scores, in parallel, against different transaction models using knobs or hedges.

Prior to discussing embodiments of the invention, description of some terms may be helpful in understanding embodiments of the invention.

A “transaction” may include exchange of data and/or information between two entities. Exemplary transactions may include purchase transactions. Such transactions may involve the use of a payment card such as a debit or credit card. A transaction may be a card-present (e.g., at a POS terminal) transaction or a card-not-present (e.g., online, phone order) transaction. Some transactions may be clearly fraudulent or clearly non-fraudulent. Some transactions may be subjected to review by a human reviewer if they are not clearly fraudulent or clearly acceptable.

“Transaction data” may refer to data relating to a transaction. The transaction data may include one or more of a transaction amount, a consumer name, a phone number, a billing address, a shipping address, an email address, an IP address, an account identifier, a merchant name, a merchant identifier, a merchant category, a location of the transaction, a product category, a product description, a quantity, merchandise information, quantity and any such suitable information related to the transaction.

A “fraudulent transaction” may refer to a transaction that was conducted by an unauthorized entity. For example, a fraudulent transaction may be conducted using a payment account that does not belong to the buyer. In some embodiments, fraud analysis algorithms may evaluate transaction data to determine if a transaction is fraudulent or not based on certain fraud rules.

A “review” of a transaction may include an analysis of transaction data. The review may be performed by a human being that is knowledgeable about the types of transactions being reviewed.

A “consumer” may be an entity, such as, an individual that may be able to conduct transactions at an access device (e.g., a POS terminal, a virtual terminal, a client computer, etc.). The transaction may relate to a purchase of goods or services.

A “rule” may include a determination operation providing a result. An example of a rule is a fraud rule. Exemplary rules may include thresholds which may trigger such rules. For example, an exemplary rule may be “flag for review if there are more than 10 items in the order.” In some embodiments, a point may be assigned to each fraud rule. Multiple fraud rules can be applied to a single profile such that each rule can contribute to an overall profile fraud score. This gives the merchant a score for the transaction by adding up the points for each rule. The overall profile score of the transaction can be used by the merchant to determine a transaction decision rule (accept, reject, review, or monitor).

An “active profile” may include a set of active rules that may be applied actively on incoming transactions. In an embodiment, the set of active rules may include two or more active rules. In some embodiments, the active profile may include rules that help determine if an incoming transaction can be approved, declined or sent for a review. In some embodiments, an active selector rule may determine which active profile to run against a transaction. The active profile may be different for different merchants, merchant categories, product categories, etc. For example, an active selector rule may apply a high risk profile on a transaction amount over $500. If the transaction amount is less than $500 and if the order is shipping to United States then the active selector rule may apply a medium risk profile. Further, if the order is not shipping to the United States and if the amount is less than $50 then the active selector rule may apply a low risk profile.

A “passive profile” may include a set of passive rules that can run in the shadow mode to record results for each transaction. In an embodiment, the set of passive rules may include two or more passive rules. In some embodiments, the passive selector rules may segregate the transactions using different variables than the active rules. For example, a passive selector rule may segregate all the transactions with overnight shipping that can be run against one passive profile, while another passive selector rule may segregate all the transactions shipping to California that can be run against another passive profile. In some embodiments, the passive profile may record transaction data for a number of days (e.g., one week or more) before determining if a passive rule catches a certain fraud and can be moved to the active profile. For example, if a fraudster makes small purchases over few days before making a bigger purchase, a rule may be built for detecting such fraudulent transactions by analyzing recorded data for those transactions over a period of time.

A “replay profile” may include a set of rules that is applied to a set of past transactions. In an embodiment, the set of rules may include two or more rules. The replay profile may include new rules or modified rules to determine their impact on past transactions.

To illustrate the differences between active, passive, and replay fraud rule profiles, a transaction for the online purchase of shoes may have been conducted. When the active fraud rule profile was applied to the transaction, the transaction may have been flagged for “review.” The passive rule profile may be run in the background and may have flagged the transaction as “reject.” The effectiveness of the passive profile may not be determined for weeks as sufficient data needs to be collected to provide for a statistically significant sampling of transactions. The replay fraud rules profile, on the other hand, can be applied immediately to any suitable collection of past transactions to determine its effectiveness without waiting for weeks.

A “server computer” is typically a powerful computer or cluster of computers. For example, the server computer can be a large mainframe, a minicomputer cluster, or a group of servers functioning as a unit. In one example, the server computer may be a database server coupled to a Web server.

An “authorization request message” may be an electronic message that is sent to a payment processing network and/or an issuer of a payment card to request authorization for a transaction. An authorization request message according to some embodiments may comply with ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CW (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g. POS equipment) that indicates approval of the transaction. The code may serve as proof of authorization. As noted above, in some embodiments, a payment processing network may generate or forward the authorization response message to the merchant.

In some cases, a profile with a certain set of rules may catch most fraudulent transactions. If it is determined that a subset of the transactions that are going into review are always getting reviewed and accepted, the rules in the profile may be adjusted so that going forward similar transactions always get accepted without review. By adjusting the rules, those transactions could be automatically accepted, but they could still result in chargebacks at a later time. The rules may be further modified to catch those chargeback transactions. However, in most cases, selecting a set of past transaction data to determine if a new rule would catch those chargeback transactions could be a challenging task, since the characteristics or status of the transaction data may have been updated to reflect the current status of the transaction (chargeback) in the transaction history. As compared to a passive fraud rule profile, embodiments of the invention enable the merchants to apply a replay profile on a set of past transactions with their original statuses to quickly determine the effectiveness of new fraud rules. For example, the original status of the transaction may be “accepted” with the modified rules. However, if the transaction turned out to be a chargeback at a later time, the current status of the transaction may indicate “chargeback” in the transaction history. In order to test the new fraud rules, it is desirable that the transaction status indicates “accepted” instead of “chargeback” so that the “accepted” transaction can be detected as a potential “chargeback” by applying the replay profile.

Generally, a passive fraud rule profile is run in a shadow mode to collect results using a set of rules against transactions. It may take days or even weeks in some cases to collect the results against a particular passive profile. As the merchants attempt to customize their set of rules and profiles for their particular industry, it is desirable for the merchants to quickly receive the results to determine which profiles and rules to use for future transactions. In some cases, it may take days or weeks to determine if a transaction is fraudulent (e.g., 30-90 days for chargeback transactions). In such cases, using a passive profile to detect a pattern for a fraudulent transaction may not provide timely results if a number of unauthorized transactions have been conducted using the same payment account before the passive profile detects the fraudulent transaction. For example, if a transaction was accepted three months ago and it turned out to be a chargeback two months ago, a rule may not have triggered three months ago to detect that transaction. However, a new rule may be put in place by analyzing the transaction data for that transaction, which may be able to reject similar future transactions. The replay engine allows testing new rules in a rapid manner as compared to an engine that uses a passive profile.

It is desirable to have an improved fraud detection system such that the orders that are clearly authentic do not get rejected or go in for review and the transactions that are clearly not authentic at least go into review if they are not rejected. Embodiments of the invention provide a system and method to quickly determine impact of new profiles and rules on past transactions. In embodiments of the invention, the replay profile preferably catches as much fraud as the default profile (e.g., active profile) in addition to any previously undetected fraud.

A set of transactions may be identified from a transaction history database based on a selection criterion. Selection criteria may include certain transaction types (e.g., credit, debit, prepaid, etc.), transactions within amounts in specific ranges (e.g., less than $25, more than $500, etc.), transactions within a specific geography (e.g., within a state, out of state, out of country, in a certain region, etc.), transactions related to a specific product category (e.g., electronics, music, clothing items, books, travel related, etc.), transactions related to number of items purchased (e.g., more than twenty), transactions occurred in certain time durations (e.g., in last three months, in a particular year, during holidays, etc.), transactions in a certain queue, transactions with specific statuses (e.g., accept, reject, review, chargeback, authentic, etc.). Some non-limiting examples of the selection criterion may be all chargeback transactions that ran three months ago, all transactions over $500 in last six months or all transactions that shipped to California last month.

In a transaction database, the set of transactions can have the original statuses (to which the active profile was applied) in order to accurately detect fraud using the new rules. Another column in the transaction database may have the current statuses of the transactions. For example, an original status for a transaction may have been “accepted” when the transaction was run, while a current status may be “chargeback” as a result of a chargeback that occurred later in time.

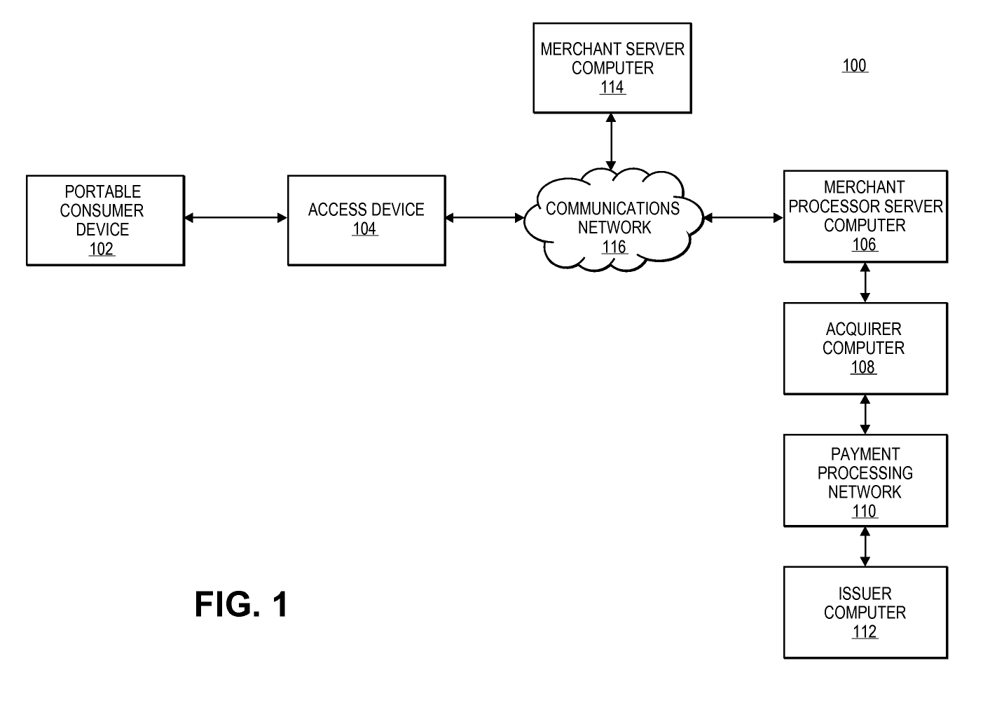

FIG. 1 illustrates an exemplary system 100 with at least some of the elements for implementing embodiments of the invention. System 100 comprises an access device 104 operatively coupled to a merchant processor server computer 106 and a merchant server computer 114 (which may operate a merchant Website) via a communications network 116. A portable consumer device 102 may interact with the access device 102 if the access device 102 is at a physical point of sale. The portable consumer device 102 may alternatively be a payment card with an associated account number. The account number may be entered into the access device 102 to conduct a transaction with the merchant operating the merchant server computer 114. An acquirer computer 108, a payment processing network 110, and an issuer computer 112, may be in operative communication and operatively coupled to each other, as well as the merchant processor server computer 106.

The portable consumer device may 102 refer to any device that may be used to conduct a financial transaction, such as to provide payment information to a merchant. The portable consumer device 102 may be in any suitable form. For example, suitable payment devices can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of payment devices include cellular phones, personal digital assistants (PDAs), pagers, payment cards, security cards, access cards, smart media, transponders, 2-D barcodes, an electronic or digital wallet, and the like. If the payment device is in the form of a debit, credit, or smartcard, the payment device may also optionally have features such as magnetic stripes. Such devices can operate in either a contact or contactless mode. In some embodiments, the portable consumer device 102 may also be configured to communicate with one or more cellular networks.

The access device 104 may be any suitable device for communicating with a merchant computer or a payment processing network, and/or for interacting with a payment device, a user computer apparatus, and/or a user mobile device. Some examples of the access device 104 include point-of-sale (POS) devices, cellular phones, PDAs, personal computers (PCs), tablet PCs, hand-held specialized readers, set-top boxes, electronic cash registers (ECRB), automated teller machines (ATMs), virtual cash registers (VCRs), kiosks, security systems, access systems, Websites, and the like. The access device 104 may use any suitable contact or contactless mode of operation to send or receive data from, or associated with, the portable consumer payment device 102 if the portable consumer device is used at a physical point of sale.

In an e-commerce transaction, the access device 104 may be capable of communicating with a merchant Website run on the merchant server computer 114. For example, the access device 104 may be a personal computer which may be used by a consumer to conduct a transaction using a payment account associated with the portable consumer device 102.

The merchant processor server computer 106 may be configured to receive transaction data from the access device 104 and/or the merchant server computer 105 via the communications network 116. The communications network 116 may comprise a plurality of networks for secure communication of data and information between different merchants and the merchant processor server computer 106. In some embodiments, the communications network 116 may follow a suitable communication protocol to generate one or more secure communication channels between the merchant processor server computer 106 and the access device 104. Any suitable communications protocol may be used for generating a communications channel. A communication channel may in some instance comprise a “secure communication channel,” which may be established in any known manner, including the use of mutual authentication and a session key and establishment of an SSL session. However, any method of creating a secure channel may be used. By establishing a secure channel, sensitive information related to a payment device (such as account number, CW values, expiration dates, etc.) may be securely transmitted between the access device 104 and the merchant processor server computer 106 to facilitate a transaction.

A suitable communications network 116 may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

The merchant processor server computer 106 may receive the transaction data for a transaction and apply a particular profile with a set of rules to determine if the transaction is clearly fraudulent, clearly not fraudulent, or indeterminate and requires further review. The transactions which are clearly fraudulent against a particular profile may be rejected. The transactions which are clearly not fraudulent may be approved. If the transaction is approved, the merchant processor server computer 106 may generate and/or transmit an authorization request message to an issuer computer 112 via a payment processing network 110 and an acquirer computer 108.

The acquirer computer 108 is typically a system for an entity (e.g., a bank) that has a business relationship with a particular merchant or other entity. The acquirer computer 108 may route the authorization request for a transaction to the issuer computer 112 via the payment processing network 110.

The payment processing network 110 may include data processing subsystems, networks, and operations used to support and deliver authorization processing, and clearing and settlement processing. An example of payment processing network 110 includes VisaNet®, operated by Visa®. The payment processing network 110 may include wired or wireless network, including the internet.

The issuer computer 112 is typically a computer run by a business entity (e.g., a bank) that may have issued the payment (credit/debit) card, account numbers or payment tokens used for the transactions. Some systems can perform both issuer computer 112 and acquirer computer 108 functions. When a transaction involves a payment account associated with the issuer computer 112, the issuer computer 112 verifies the account and responds with an authorization response message to the acquirer computer 108 that may be forwarded to the corresponding access device and the consumer device if applicable. If the authorization is approved, the transaction may be completed and the consumer associated with the transaction may be notified that the transaction was successfully completed.

At a later time (e.g., at the end of the day), a clearing and settlement process can occur between the acquirer computer 108, the payment processing network 110, and the issuer computer 112.

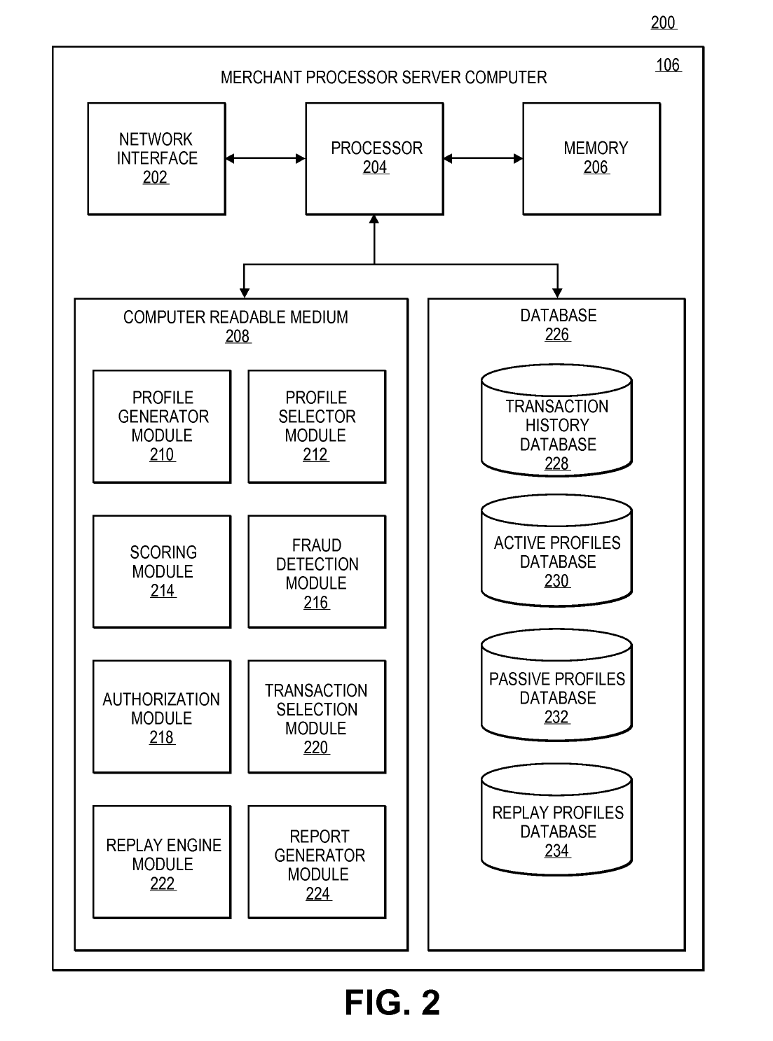

FIG. 2 illustrates at least some of the elements of the merchant processor server computer 106 in accordance with embodiments of the invention.

The merchant processor server computer 106 may be configured to receive a plurality of transactions and to apply fraud rules to determine which transactions may be approved, rejected or sent for review or monitor. The merchant processor server computer 106 may comprise a network interface 202, which may be configured to interface with other entities, such as, the acquirer computer 108, and the access device 104, etc. for the exchange of data and information (e.g., transaction and authorization related data) using various communications networks. It may also include a memory 206 may be coupled to a processor 204 internally or externally (e.g., cloud based data storage) and may comprise any combination of volatile and/or non-volatile memory such as, for example, buffer memory, RAM, DRAM, ROM, flash, or any other suitable memory device. The network interface 202 may employ connection protocols such as, but not limited to: direct connect, Ethernet (thick, thin, twisted pair 10/100/1000 Base T, and/or the like), Token Ring, wireless connection such as IEEE 802.11a-x, and/or the like. Further, multiple network interfaces may be used to engage with various communications network types. For example, multiple network interfaces may be employed to allow for the communication over broadcast, multicast, and/or unicast networks.

The processor 204 or processing elements may be configured to execute instructions or code in order to implement methods, processes or operations. The merchant processor server computer 106 may also include a computer readable medium (CRM) 208, which may also be in the form of a memory, and may comprise code, executable by the processor 204 for implementing methods described herein. The CRM 204 may comprise a profile generator module 210, a profile selector module 212, a scoring module 214, a fraud detection module 216, an authorization module 218, a transaction selection module 220, a replay engine module 222, and a report generator module 224.

The merchant processor server computer 106 may also comprise a database 226 communicatively coupled to the processor 204. The database 226 may be embodied by a memory as well and may comprise a transaction history database 228, an active profiles database 230, a passive profiles database 232, and a replay profiles database 234. In some embodiments, some or all the components of the database 226 may be external (e.g., cloud storage). The database 226 may be a conventional, fault tolerant, relational, scalable, secure database such as Oracle or Sybase. Alternatively, the database 226 may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. The database 226 may also be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

The profile generator module 210 may be configured to generate various profiles with rules for fraud detection, e.g., an active profile, a passive profile and a replay profile. An active profile may include active rules to make decisions on incoming transactions. In one embodiment, the active profile rules may determine if an incoming transaction may be approved, rejected, monitored or sent for review based on a score generated by analyzing transaction data. As an example, an active rule may be to accept a transaction if the transaction amount is less than $25 and the shipping address is same as the billing address. In another example, an active rule may be to reject a transaction if the transaction amount is over $500 and the shipping address is outside the Unites States. In one embodiment, the active profile may be generated or updated by a merchant using a web interface. Active rules may be generated based on a number of factors, such as, merchant categories, product categories, merchant locations, industry type, transaction amounts, consumer's transaction history, etc. In one embodiment, the active profiles may be stored in the active profile database 230.

A passive profile may include passive rules to monitor the transactions in passive mode for a period of time, e.g., one week, two weeks, a month, and record the results. The results may be analyzed to determine if a passive rule catches a particular fraud that was not caught by the active profile, and accordingly the passive rule may be moved to the active profile. The passive profiles may be stored in the passive profile database 232.

A replay profile may include replay rules to run against past transactions. In one embodiment, the replay profile may be applied to a set of past transactions selected by a merchant using a web interface. A replay report may be generated for the merchant to analyze the effect of new rules on the set of past transactions. In one embodiment, the replay profile is applied on past transactions having original statuses to which the active profile was applied. For example, if a transaction was approved as it came in (by the active profile) but later on it turned out to be a chargeback, the replay profile is applied on that transaction without having the knowledge that it was a chargeback transaction. In embodiments of the invention, the replay profile may generate results in a quicker manner as compared to the passive profile. In one embodiment, the replay profiles may be stored in the replay profile database 234.

The profile selector module 212 may include selector rules to select which profile to apply on a transaction. An active profile selector rule may apply active rules to select active profiles from the active profile database 230. A passive profile selector rule may apply passive rules to select passive profiles from the passive profile database 232. A replay profile selector rule may apply replay rules to select replay profiles from the replay profile database 234. In embodiments of the invention, there may be different types of transaction models (e.g., travel model, digital model, custom model, call center model, etc.) that may be utilized by each profile. A transaction model may include a plurality of fraud rules for a particular merchant based on the specific needs of their business or industry. For example, a travel model may include rules for airline tickets, hotel reservations, car rentals, etc. The rules for travel model may include different rules based on specific characteristics of the travel industry in each region, e.g., Asia, Europe, North America, and such. In another example, a digital model may include rules for transactions relating to downloads of music, movies or software and subscriptions, etc.

In embodiments of the invention, transaction data associated with a transaction may be analyzed to determine which profile may be selected. The transaction data may include one or more of a transaction amount, a consumer name, a phone number, a billing address, a shipping address, an email address, an IP address, an account identifier, a merchant name, a merchant identifier, a location of the transaction, a quantity, merchandise information, and any such suitable information related to the transaction. In some embodiments, transaction data is stored in the transaction history database 228 at the transaction time for replay purposes. Past transaction data 106 may include data relating to a plurality of transactions that were selected using transaction selection criterion 102. In some embodiments, past transaction data 106 may comprise at least 10, 100, 1000, or even over 10,000 transactions that may be payment transactions.

The scoring module 214 may be configured to generate scores for each transaction based on certain detectors. In an embodiment, a detector is a test that may be triggered or fired based on certain conditions associated with the transaction data. An information code may be generated based on the outcome of the detectors that may be used to generate or evaluate the rules. For example, for each transaction, a set of detectors may monitor the phone number associated with the transaction data, another set of detectors may monitor the shipping address versus the billing address, and yet another set of detectors may monitor the IP address associated with the transaction. In one embodiment, a detector may be implemented as a Boolean test, e.g., a condition is met (yes) or not met (no). In another embodiment, a detector may be implemented as a categorical test, e.g., there may be four possible outcomes—one with points 0-2, two with points 3-5, three with points 6-8 and four with points 9-10. In another embodiment, a detector may be implemented as a quantitative test, e.g., certain number of points may be assigned based on which conditions are met.

In one embodiment, different information codes may be generated for different transaction models depending on which detectors are fired. The information codes give suitable information back to the merchant based on the triggered tests that may be used to generate or evaluate the rules. As an example, a credit card detector test may be fired true if the merchant account of a consumer used for the transaction involves a high number of credit cards (e.g., more than 5). In one embodiment, the credit card detector test may be implemented as being true if the points generated by a set of detectors add up to 25 or more and false if the points are below 25. The information code gives suitable information back to the merchant based on the triggered test, for example, the information code may indicate “multiple credit cards”. There may be a rule in the profile which takes into account the information code and other conditions for accepting or rejecting the transaction. For example, a rule may specify that if the information code indicates “multiple credit cards” and if the transaction amount is over $500, reject the transaction. In another example, a detector may be fired true if the shipping address does not match with the billing address for the transaction. Accordingly, an information code indicating “multiple matches billing shipping” may be returned to the merchant. A rule in the profile that checks for whether the shipping address matches with the billing address may be triggered if the information code is equal to “multiple matches billing shipping”. Accordingly, the transaction may be rejected or sent for review.

In one embodiment of the invention, a point can be assigned to each rule that can be weighted. Multiple fraud rules can be applied to a single profile such that each rule can contribute to an overall profile fraud score. This gives the merchant a score for the transaction by adding up the points for each rule. The profile score of the transaction can be used by the merchant to determine transaction decision rule (accept, reject, review, or monitor). For example, a transaction with a score over 75 may be rejected, a transaction with a score less than 25 may be approved, a transaction with a score between 25 and 50 may be monitored and a transaction with a score between 50 and 75 may be forwarded for review. Details of generating a scoreboard based on a merchant profile can be found in co-pending U.S. application No. 61/599,797, entitled “Custom Scoreboard and Hybrid Fraud Model” by Andrew John Bruno Naumann Zu Koenigsbrueck and Cory H. Siddens, and B. Scott Boding, filed on Feb. 16, 2012.

Embodiments of the invention further enable a merchant to run a transaction against multiple profiles in parallel utilizing different transaction models. In one embodiment, a hedge or a knob may be used for each transaction model to control the weight of a particular category (e.g., transaction velocity, address, phone number, transaction amount, etc.) related to the transaction depending on its significance. Some non-limiting examples of hedges include transaction velocity, phone number, shipping address, number of purchased items, and such. The merchants may be able to tune the hedges for different categories for each transaction model so that the profile score generated for that transaction model has less weight for a particular category as compared to other categories.

In embodiments of the invention, different detectors may be tuned (given different weightage) based on type of the transaction model. For example, detectors for a digital model may be tuned to analyze IP address of the computer associated with the consumer instead of the shipping address, since the shipping address information may be irrelevant for digital products that are not delivered to a physical address. In such a model, the detectors for the shipping address may be disabled. In another example, a call center model may include rules for transactions conducted over the telephone. Detectors for such model may be tuned to analyze phone number of the consumers. In such models, the detectors for the IP address of the computer associated with the consumer or consumer's email may be disabled. Some other types of transaction models may include a consumer electronics model, a jewelry model, etc. that may further be categorized into different regional models.

Embodiments of the invention allow for rescoring using different transaction models on different settings without rerunning the transactions. In one embodiment, scores for multiple transaction models can be generated in parallel. In one embodiment, hedge settings can be tuned for different transaction models that enable the users to replay it or use it in passive profile to effectively re-score the transactions without actually happen to do the full re-scoring. This enables the merchant to quickly determine the impact of new rules and profiles for making decisions for future transactions.

The fraud detection module 216 may be configured to determine if a transaction should be accepted, rejected, monitored or sent for review based on a score generated by the scoring module 214. For example, if the score is less than 25, the transaction may be accepted. If the score is between 25 and 50, the transaction may be monitored. If the score is between 50 and 75, the transaction may be sent for a review. If the score is more than 75, the transaction may be rejected.

The authorization module 218 may be configured to generate and process authorization request and response messages. The authorization module 218 may also determine the appropriate destination for the authorization request and response messages. The authorization module 218 may be configured to generate an authorization request message for further processing of the clearly non-fraudulent transactions by the payment processing network 110 via the acquirer computer 108. The issuer computer 112 and the payment processing network 110 may transmit an authorization response message back indicating whether the transaction is approved or declined.

The transaction selection module 220 may provide a merchant with options to select a plurality of transactions from the transaction history database 228 for applying a replay profile. For example, a merchant can select transactions for a certain duration (last month, last 3 months, month to date, etc.), for a transaction amount over a certain amount (e.g., $500), for a transaction status (e.g., chargebacks), for an out of country address (e.g., outside United States), for a transaction type (e.g., credit), for a product category, etc. One embodiment of the invention enables the merchant to utilize a web interface for selecting a set of transactions and scheduling it for replay.

The replay engine module 222 may be configured to apply the replay profile on the plurality of transactions selected based on a certain criteria. The replay profile may include new rules to determine if the fraud detection can be improved with the new rules as compared to the active profile. In some embodiments, the replay profile may include new rules so that the number of transactions processed by the replay profile has a reduced number of false positive transactions and a reduced number of false negative transactions than the transactions processed by the active profile. For example, a false positive transaction may be a transaction which was approved by the active rule but was in fact a fraudulent transaction. A false negative transaction is a transaction that was originally flagged as false, but was in fact authentic. In some embodiments, a number of replays may be batched and the merchants may be notified when the replay reports are available.

The report generator module 224 may be configured to generate different reports against each profile. An active profile report may include results of applying the active profile against a plurality of transactions. A passive profile report may include results of applying the passive profile against a plurality of transactions. A replay profile report may include results of applying the replay profile against a plurality of transactions. In one embodiment, the replay profile report may be generated in a tic-tac-toe format.

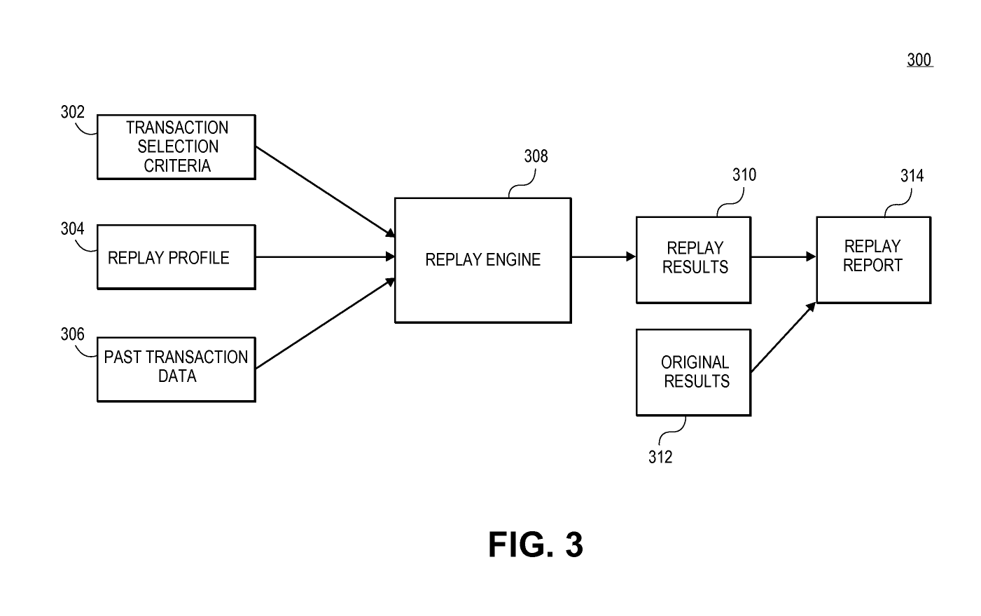

FIG. 3 illustrates an exemplary replay system 300, which includes a replay engine 308 for applying a replay profile 304 on past transaction data 306 that has been selected using a transaction selection criterion 302. Replay results 310 are compared against original results 312 to generate a replay report 314 that provides net impact of the new configuration of rules as compared to the old configuration.

In one embodiment, the transaction selection criterion 302 is provided by the transaction selection module 220 that may be used to select the past transaction data 306. In one embodiment, a user interface may be provided to a client computer (e.g., the access device 104) associated with a merchant with options to select a set of transactions on which the replay profile may be applied. The transactions may be selected based on one or more criteria, e.g., all transactions conducted in last 3 months, all transactions with chargebacks, all transactions in a certain queue, all transactions over $500 shipped to Nevada, etc.

The replay profile 304 may be generated by the profile generator module 210 and stored in the replay profile database 234. The replay profile may be based on a transaction model and may include one or more replay rules. In some embodiments, the replay profile may be selected by the profile selector module 212 using a replay profile selector rule (e.g., a rule for all overnight shipping transactions).

In some embodiments, in order for the replay profile to accurately provide replay results, the past transaction data 306 keeps the original statuses (i.e., at the time transaction was conducted) as well as the updated statuses for each transaction. For example, if a transaction was approved when it was conducted, the original status of the transaction shows “approved”. At a later time, if the transaction turns out to be a chargeback, the modified or updated status may show “chargeback”.

In one embodiment, the replay engine 308 utilizes the replay engine module 222, which applies the replay profile 304 on the past transaction data 306. In one embodiment, a merchant may be able to queue up a replay by selecting a “Replay” button via a user interface on a client computer associated with the merchant. In one embodiment, permission may be required from an authorized user for scheduling a replay. The replay engine 308 generates the replay results 310 which are compared against the original results 312. In one embodiment, the original results 312 are the results generated by applying the active profile on the past transaction data 306. The replay report 314 may be generated by the report generator module 224. In one embodiment, the replay report 314 is in a tic-tac-toe format displaying shift in the results between the two profiles. In one embodiment, while a replay is pending in a queue, editing of replay profile may be locked to avoid corrupted results.

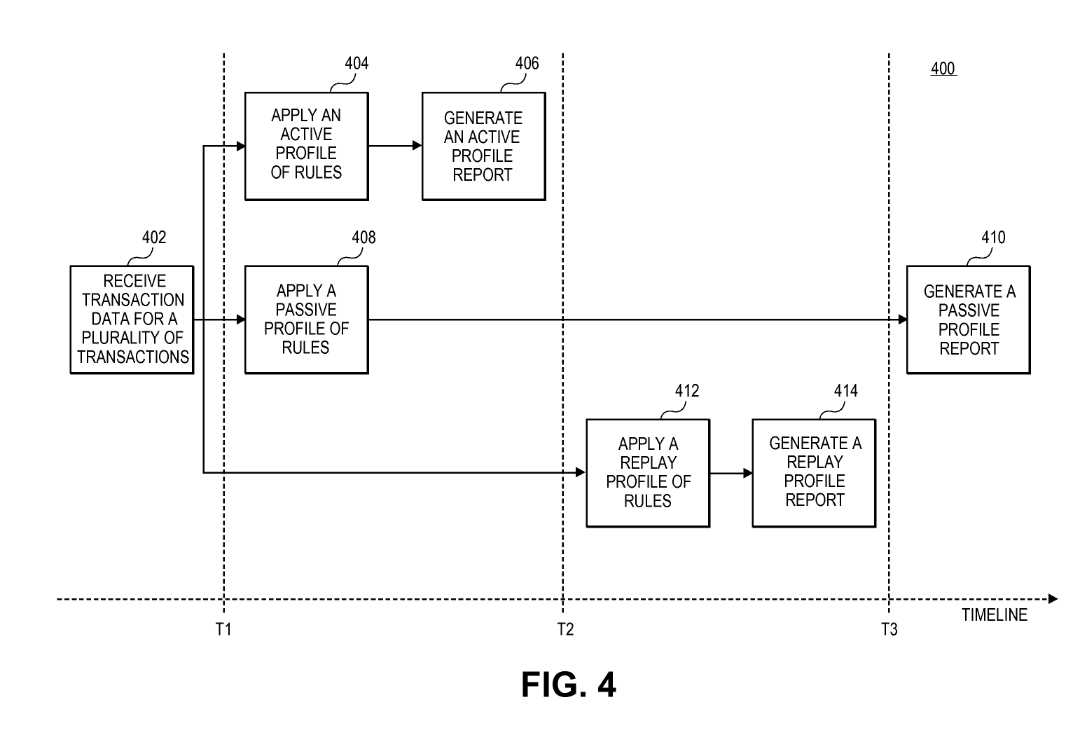

FIG. 4 illustrates an exemplary process flow 400, in one embodiment of the invention.

In step 402, transaction data for a plurality of transactions is received by the server computer 200. The transaction data may be for transactions received over a period of time. In some embodiments, the transaction data may be stored in the transaction history database 228.

In step 404, an active profile of rules may be applied to the plurality of transactions at a time T1 on the timeline. The active profile may be generated by the profile generator module 210 and selected by the profile selector module 212. The fraud detection module 216 may apply the active profile on the plurality of transactions to determine a transaction decision for each transaction, e.g., approve, decline, review or monitor. In one embodiment, the plurality of transactions may have a first set of statuses at time T1 that may be stored in the transaction history database 228 along with transaction data for replay purposes.

In step 406, an active profile report is generated by the report generator module 224. Since the active profile is applied on incoming transactions, the active profile report may be generated almost instantly. The active profile report may include the authorization decision (e.g., approve, decline, monitor or review) for each transaction. In some embodiments, the active profile report may include an information code for the merchants to help understand the authorization decision.

In step 408, a passive profile of rules is applied to the plurality of transactions at time T1. In one embodiment, some or all of the passive rules are different than the active rules. Applying the passive profile is done in shadow mode, i.e., it does not have an effect on the authorization of the incoming transaction. The passive profile may take days or weeks to collect and analyze the data for the plurality of transactions.

In step 410, a passive profile report is generated at a time T3 as a result of applying the passive profile of rules at time T1. The passive profile report may be generated at a time much later (e.g., few days or couple of weeks) than the active profile report. The passive profile report may include a suggested authorization decision for each transaction which may be same or different than the active profile report. For example, a transaction that went in to review by applying the active profile may be rejected by applying the passive profile. In some embodiments, by collecting data over a number of days, a passive profile rule may be able to detect a pattern for a fraudulent transaction, which may not have been detected by the active profile. In some embodiments, that passive profile rule may be moved to the active profile to be used for future transactions.

In step 412, a replay profile of rules is applied to the plurality of transactions at time T2, which may be later than time T1 but before time T3 (e.g., to test a new profile in a quick manner as compared to a passive profile which may take longer). In some embodiments, the replay profile may be applied at a time later than time T3. The replay profile is applied to the plurality of transactions with a first set of statuses (e.g., same as time T1) even though the plurality of transactions may have been updated with a second set of statuses at time T2. For example, a transaction that was approved (first status) with an active profile at time T1 may have turned out to be a chargeback (second status) at time T2. The replay profile may include replay rules which may or may not overlap with passive rules.

In step 414, a replay report is generated as a result of applying the replay profile. The replay report shows a shift in results by comparing the active profile report with the replay profile report to determine if the replay profile is more favorable than the active profile. In one embodiment, the replay profile is more favorable than the active profile when the number of transactions processed by the replay profile has a reduced number of false positive transactions and a reduced number of false negative transactions than the transactions processed by the active profile. For example, if a transaction was marked for review in the active profile report may be marked as accepted in the replay profile report (false negative), or a transaction that was marked for accept in the active profile report may be marked as rejected in the replay profile report (false positive).

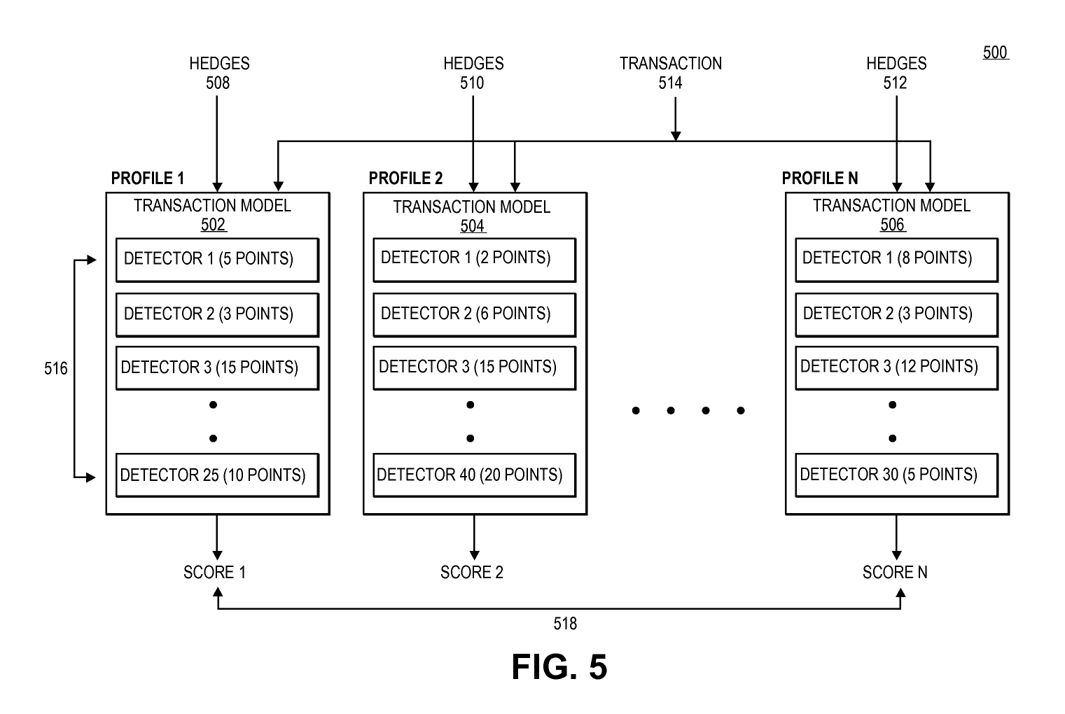

FIG. 5 shows a block diagram 500 illustrating an embodiment of the invention for generating multiple scores in parallel against different transaction models.

In one embodiment, a profile 1 uses a transaction model 502 to generate a score 1 for a transaction 514, a profile 2 uses a transaction model 504 to generate a score 2 for the transaction 514, and a profile N uses the transaction model 506 to generate a score N for the transaction 514. For illustrative purposes, the score 1, score 2 and the score N are referred to as scores 518. In one embodiment, the transaction model 502 is a digital model, the transaction model 504 is a custom model and the transaction model 506 is a travel model.

Each transaction model may include a plurality of detectors 516, some or all of which may get fired if the transaction data associated with the transaction 514 meets certain criteria. Each detector from the plurality of detectors 516 may be assigned a point or a weightage that may be tuned for different categories associated with the transaction data (e.g., address, phone number, transaction velocity, transaction amount, etc.) using the corresponding hedges or knobs. In embodiments of the invention, the hedges allow the merchants to enable or disable different detectors in the transaction model that may be specific to each merchant or the industry. For example, hedges 508 for the transaction model 502 may tune detector 1 and detector 25 to give more weightage to the email address and tune detector 3 to give less weightage to the shipping address, whereas hedges 510 for the transaction model 504 may tune detector 3 and detector 40 to give more weightage to the phone number and disable detector 2 to give no weightage to the email address.

In one embodiment, the profile1, profile 2 and the profile N may be applied to the transaction model 502, transaction model 504 and the transaction model 506 respectively to generate the score 1, score 2 and the score N in parallel. In one embodiment, the same transaction model may be used with different hedges, whereas, in another embodiment, more than one transaction models may be used. In one embodiment, a score is generated from totaling up the points for each triggered detector that can be used to determine the transaction decision rules (accept, reject, review or monitor).

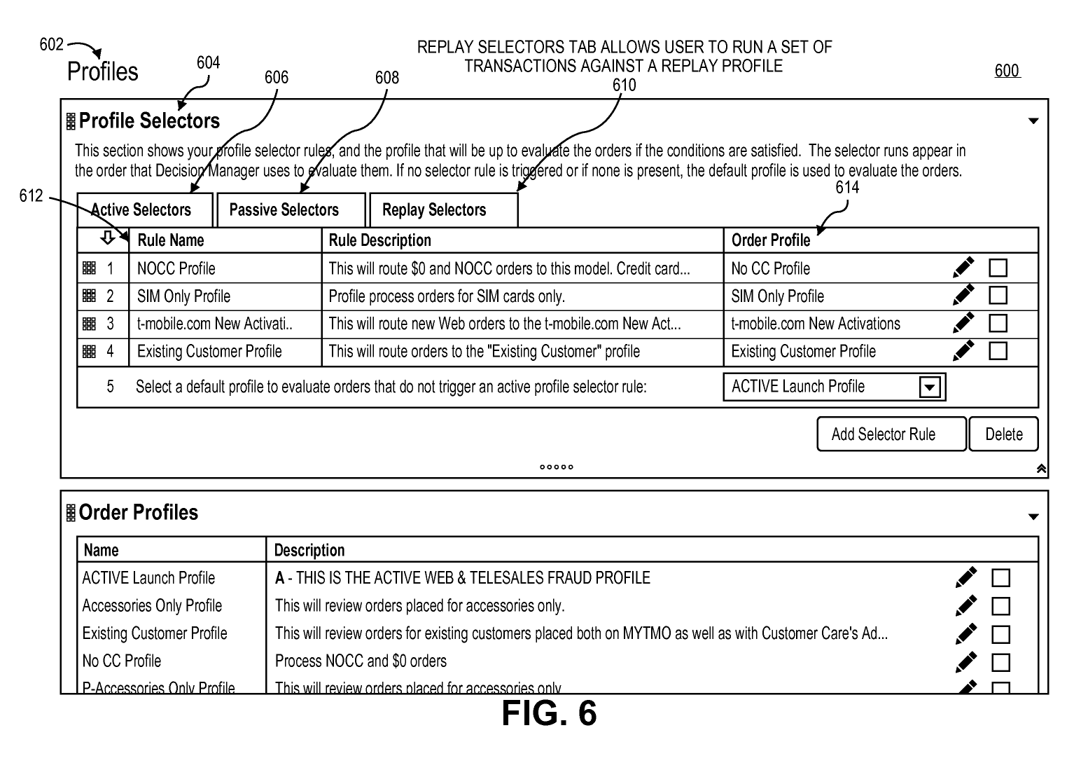

FIG. 6 illustrates an exemplary screen shot 600 displaying a user interface for selecting a profile.

As illustrated in the figure, a merchant may select profiles 602 using profile selectors 604. The merchant can further choose active selectors 606, passive selectors 608 or replay selectors 610 to select a corresponding profile that may be applied to a transaction. In one embodiment, the active selectors 606, passive selectors 608 or the replay selectors 610 are generated by the profile selector module 212 and enable the merchants to select a profile that may have been generated by the profile generator module 210.

As illustrated in the figure, the profile selectors 604 illustrate rules 612 that may be used to select a profile for evaluating each order. An order profile 614 may be selected by selecting the corresponding rule 612. For example, by selecting Rule 1, “No CC profile” is selected. If no selector rule is triggered or present, a default profile (i.e., Rule 5) may be selected to evaluate the orders. In some embodiments, up to 100 active and 100 passive selector rules may be created.

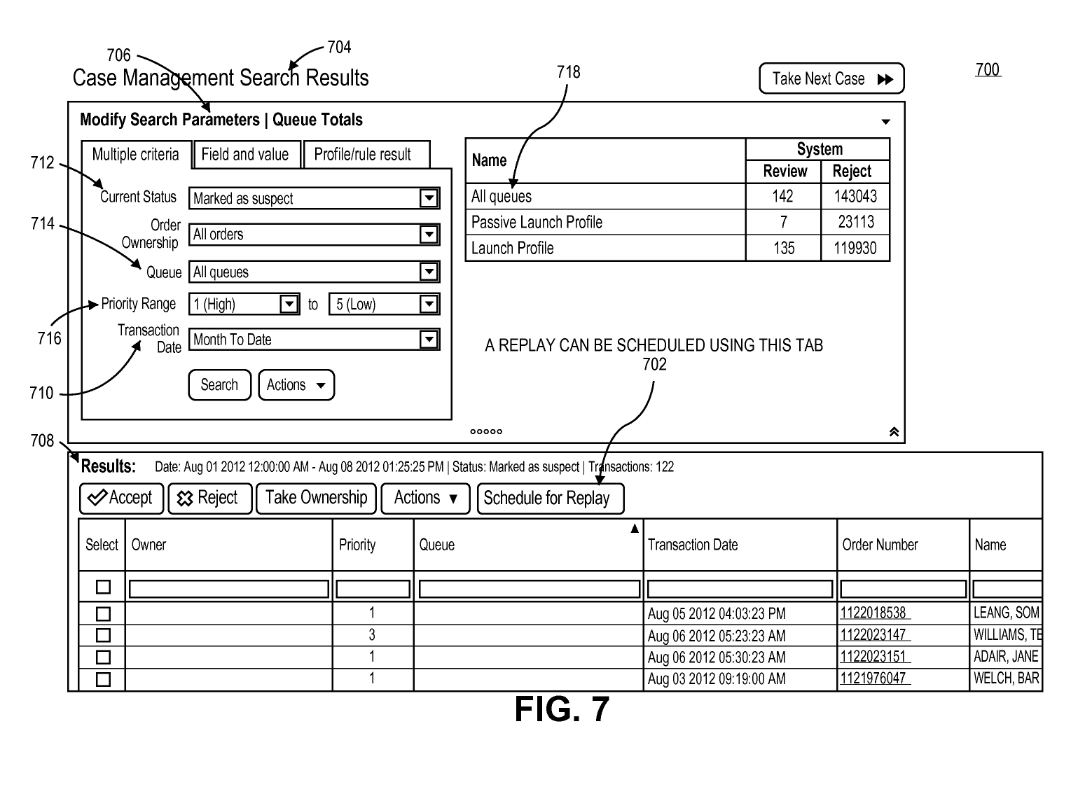

FIG. 7 illustrates an exemplary screen shot 700 displaying a user interface for selecting past transactions in one embodiment of the invention.

A Case Management Search Results (CMSR) screen 704 display the results 708 based on a selection criterion. A modify search parameter tab 706 allows a merchant to select the search parameters for selecting a set of transactions from a queue 714. As an example, the transaction selection criterion could be “transactions occurred in last six weeks”, “transactions with charge backs”, “transactions initiated in Canada”, etc. For example, based on the selection criteria, there could be 100 out of 1000 transactions or 500 out of 2000 transactions selected for replay against the new profiles. The queue 714 may store a plurality of transactions, e.g., in the transaction history database 228. In one embodiment, the transaction selection criteria 302 is used to select various fields in the modify search parameters 706 (e.g., a transaction date 710, a current status 712, a priority range 716, etc.) tab to select a set of past transactions such as the past transaction data 306 from all queues 718.

The results 708 displays a set of transaction data (including transaction date, order number, name, etc.) that was selected based on the transaction selection criteria 302, which can be scheduled for replay using the tab 702 against the replay profile 304. In one embodiment, the replay engine module 222 applies the replay profile 304 on the selected transactions and a replay report is generated by the report generator module 224.

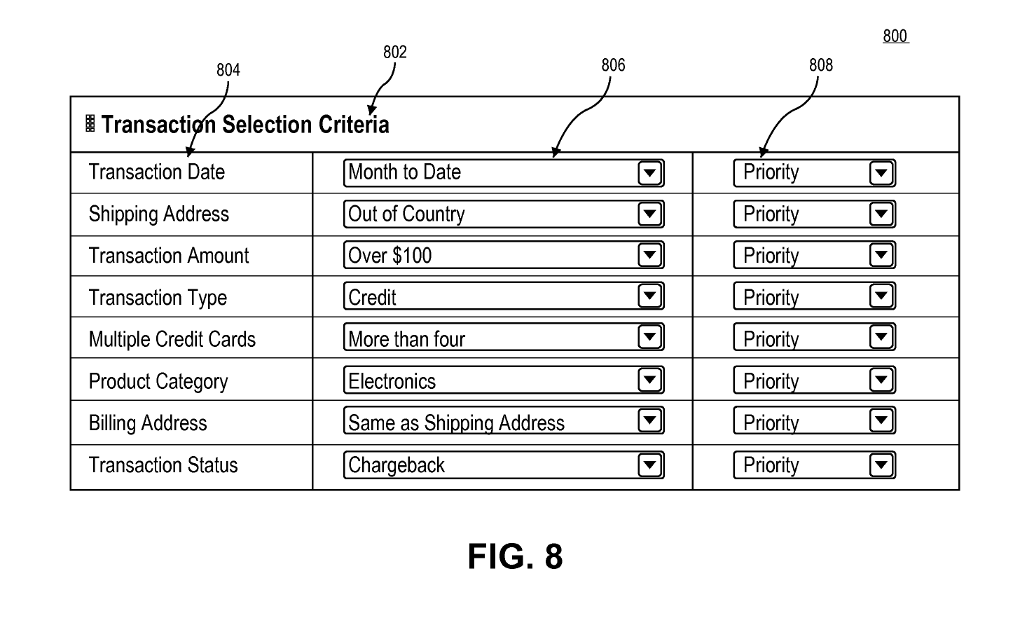

FIG. 8 illustrates an exemplary screen shot 800 displaying a user interface for selecting past transactions based on multiple transaction selection criteria in one embodiment of the invention.

As illustrated in the figure, a transaction selection criteria 802 may include multiple criteria for selecting past transactions. Merchants can use a tab 806 to select transactions based on a category 804, such as, a transaction amount, a product category, a transaction type, a transaction date, etc. A priority 808 allows the merchants to assign priority to each category. For example, multiple credit cards may have a priority 5, whereas, the product category may have a priority 2.

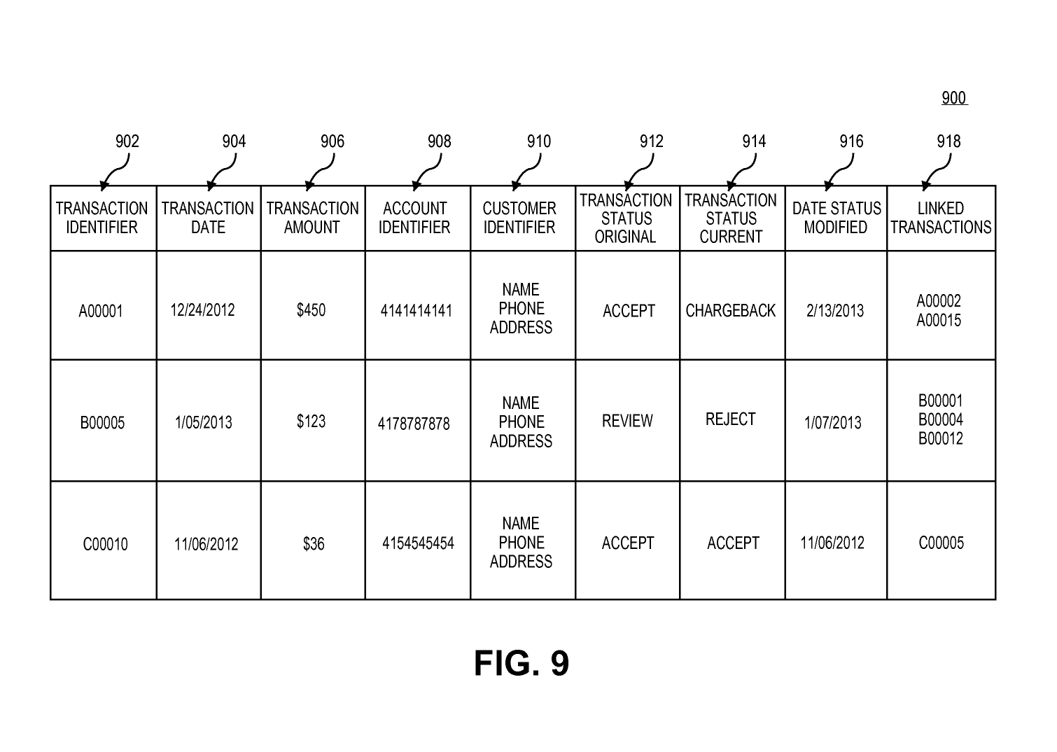

FIG. 9 illustrates an exemplary table 900 displaying an embodiment of the invention for storing at least some components of the transaction data.

A transaction identifier 902 may identify a transaction and may be used to identify other linked transactions, as illustrated in linked transactions 918. A transaction date 904 indicates the date when the transaction was conducted, and a date 916 indicates the date when the status was last modified. A transaction amount 906 indicates an amount of the transaction. An account identifier 908 may be an identifier for a payment account (e.g., payment account number) used for the transaction. A customer identifier 910 may include an identifier for the customer associated with the payment account based on the account identifier 908. The customer identifier 910 may include the customer's personal information, such as, a name, a phone number, a shipping address, a billing address, an email address, and any such relevant information associated with the customer.

A transaction status 912 indicates an original or first status of the transaction when the transaction was conducted. A transaction status 914 indicates a current (or second) status of the transaction, i.e., last modified status. For example, a transaction with a transaction identifier A00001 was conducted on Dec. 24, 2012 and the original status as indicated by the transaction status 912 shows “Accept”. At a later time, the same transaction turned out to be a chargeback and the current status of the transaction as indicated by the transaction status 914 shows “Chargeback” modified on Feb. 13, 2013. Note that there may be linked transactions 918 to this transaction as indicated by the transaction identifiers A00002 and A00015. The linked transactions 918 may be used by the fraud rules to make an authorization decision.

Embodiments of the invention apply a replay profile on past transactions having original transaction statuses for testing new rules so that the replay results may be used to determine if the new rules can be used to detect transactions that turned out to be fraudulent later on and were not detected earlier with the active profile.

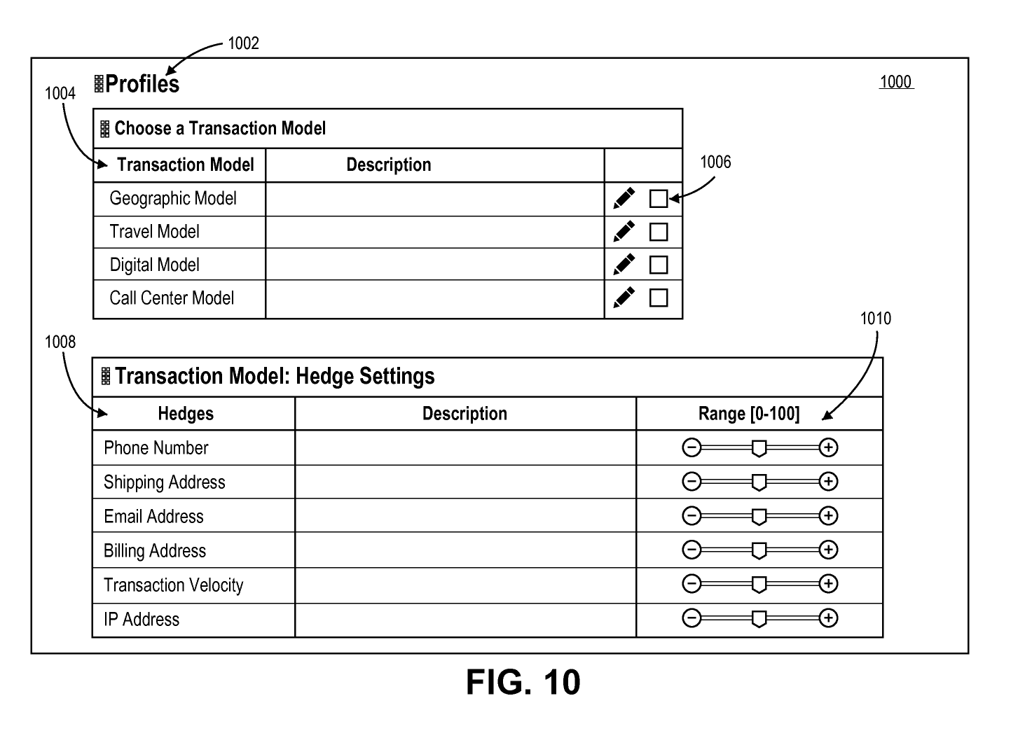

FIG. 10 illustrates an exemplary screen shot 1000 for a user interface for tuning hedge settings in an embodiment of the invention.

As illustrated in the screen shot 1000, under profiles 1002, a transaction model 1004 may be selected by clicking on a button 1006. For each transaction model, hedges 1008 may be tuned using a slider 1010 for the range. For example, for a digital model, hedges 1008 for the shipping address may be set to 0 using the slider 1010, for the IP address may be set to 100 and for the phone number may be set to 60. Tuning the hedges 1008 allows the merchants to enable or disable detectors for each transaction model, as discussed with reference to FIG. 5. In one embodiment, the scoring module 214 determines scores for each transaction model based on the hedges 1008. In some embodiments, scores for multiple transaction models may be generated in parallel for different hedge settings.

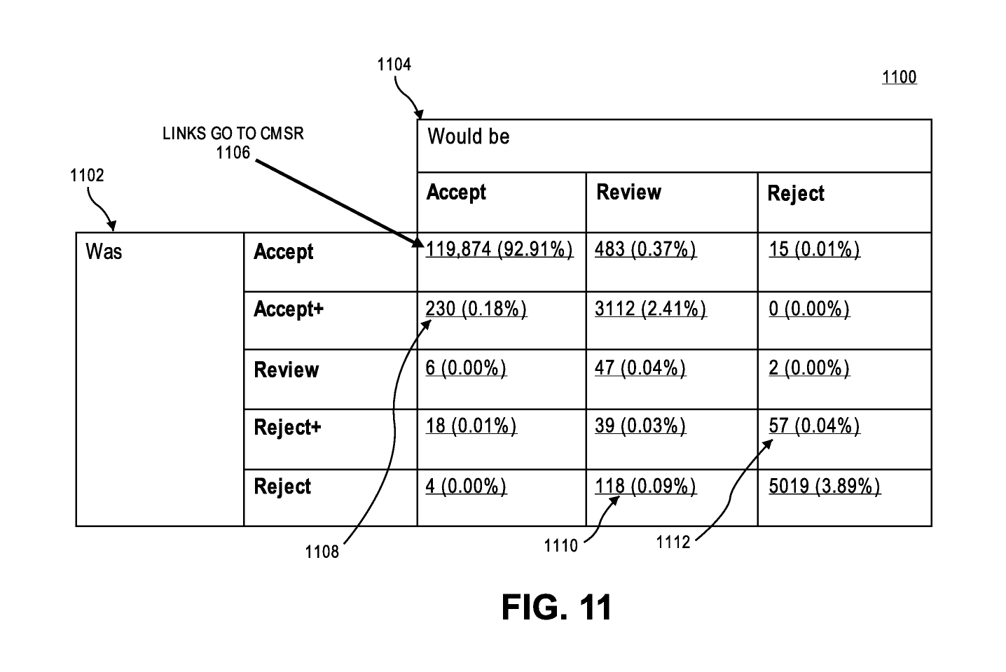

FIG. 11 illustrates an exemplary replay report 1100 with an x-axis 1104 showing a “would be” scenario and a y-axis 1102 showing a “was” scenario. In one embodiment, the replay report 1100 is similar to the replay report 314 and is generated in a “tic-tac-toe” format showing a percentage change in the original results 312 versus the replay results 310. In one embodiment, the y-axis 1102 displays different outcomes (accept, accept+, review, reject+, and reject) based on an active profile report (step 406) generated as a result of applying an active profile of rules (step 404) on a plurality of transactions (step 402). In one embodiment, the x-axis 1104 displays different outcomes (accept, review, and reject) based on a replay profile report (step 414) generated as a result of applying a replay profile of rules (step 412) on the plurality of transactions (step 402).

Entries in the replay report 1100 display the shift in transactions from one result (active) to another result (replay). The accept+ indicates a number of transactions that were sent for a review and were accepted as a result of the review and reject+ indicates a number of transactions that were sent for a review and were rejected as a result of the review. In one embodiment, the plurality of transactions is selected from the CMSR 704. In another embodiment, the plurality of transactions is selected based on the transaction selection criteria 802.

In one embodiment, an entry 1108 displays 230 transactions (0.18% of the total transactions), which were accepted after a review with the default profile, are automatically accepted with the replay profile. Similarly, an entry 1110 displays 118 transactions (0.09% of the total transactions), which were rejected with the default profile, are marked for review with the replay profile. Another entry 1112 displays 57 transactions (0.04% of the total transactions), which were rejected after a review with the default profile, are automatically rejected with the replay profile.

The replay report 1100 provides a quick and easy interface for the merchants to see a shift in results using new profile rules to determine if those rules may be used in future transactions to prevent fraud. Further, merchants can use this information to determine what percentage of rules may need to be reviewed by a human reviewer as a result of new profile versus the old profile. Merchants can accordingly modify, delete and/or add rules to further customize their profile.

Embodiments of the invention enable a merchant to replay a set of past transaction data against different profiles to determine the impact of those profiles (rules) on past transactions in a quick manner. The replay may be performed as a batch process and the results may be provided to the merchant for comparison against the default profile. This method enables the merchants to try out new set of rules and profiles by running it against a set of transaction data offline with quick turnaround (in order of minutes) without having to run these rules and profiles overnight or couple of days (e.g., with a passive profile).

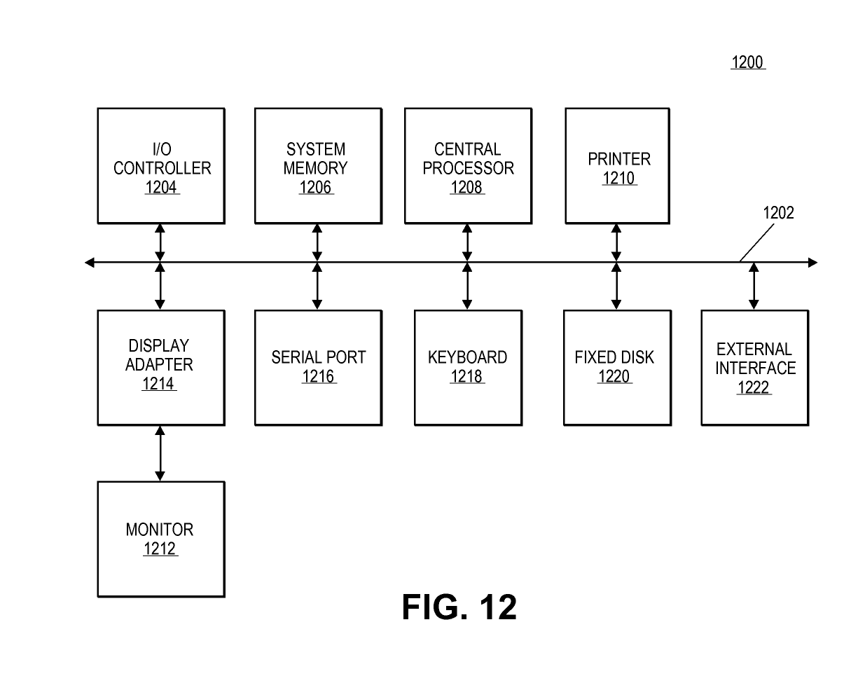

FIG. 12 is a high level block diagram of a computer system that may be used to implement any of the entities or components described above. The subsystems shown in FIG. 12 are interconnected via a system bus 1202. Additional subsystems include a printer 1210, keyboard 1218, fixed disk 1220, and monitor 1212, which is coupled to display adapter 1214. Peripherals and input/output (I/O) devices, which couple to I/O controller 1204, can be connected to the computer system by any number of means known in the art, such as a serial port. For example, serial port 1216 or external interface 1222 can be used to connect the computer apparatus to a wide area network such as the Internet, a mouse input device, or a scanner. The interconnection via system bus 1202 allows the central processor 1208 to communicate with each subsystem and to control the execution of instructions from system memory 1206 or the fixed disk 1220, as well as the exchange of information between subsystems. The system memory 1206 and/or the fixed disk may embody a computer-readable medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc. In other embodiments, the functions, processes, operations or method steps may be implemented by firmware or a dedicated processor, integrated circuit, etc.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving transaction data for a plurality of transactions;
applying, by a server computer, an active profile of rules to the plurality of transactions;
after receiving the transaction data and applying the active profile of rules, applying, by the server computer, a replay profile to the plurality of transactions; and
generating, by the server computer, a replay profile report as a result of applying the replay profile.

2. The method of claim 1, wherein applying the active profile of rules to the plurality of transactions comprises applying the active profile of rules to each transaction in the plurality of transactions.

3. The method of claim 1, wherein after applying the active profile of rules to the plurality of transactions, the method comprises:
generating an active profile report; and
comparing the active profile report to the replay profile report to determine if the replay profile is more favorable than the active profile.

4. The method of claim 3, wherein the replay profile is more favorable than the active profile when the number of transactions processed by the replay profile has a reduced number of false positive transactions and a reduced number of false negative transactions than the transactions processed by the active profile.

5. The method of claim 1 further comprising:
applying a passive profile of rules to the plurality of transactions at the same time as applying the active profile of rules to the plurality of transactions; and
generating a passive profile report as a result of applying the passive profile.

6. The method of claim 1, wherein applying the active profile of rules to the plurality of transactions occurs at a first time, and applying the replay profile to the plurality of transactions occurs at a second time subsequent to the first time.

7. The method of claim 6, wherein the plurality of transactions at the first time have a set of first statuses and the plurality of transactions at the second time have a set of second statuses.

8. The method of claim 7, wherein the replay profile is applied to the plurality of transactions having the first statuses.

9. The method of claim 1, wherein the replay profile utilizes a transaction model and generates a score for that transaction model.

10. The method of claim 9, wherein multiple scores can be generated in parallel for different transaction models by applying different hedge settings.

11. A server computer comprising:
a processor;
a computer readable medium coupled to the processor, the computer readable medium comprising code, executable by the processor for implementing a method comprising:
receiving transaction data for a plurality of transactions;
applying an active profile of rules to the plurality of transactions;
after receiving the transaction data and applying the active profile of rules, applying a replay profile to the plurality of transactions; and
generating a replay profile report as a result of applying the replay profile.

12. The server computer of claim 11, wherein applying the active profile of rules to the plurality of transactions occurs at a first time, and applying the replay profile to the plurality of transactions occurs at a second time subsequent to the first time.

13. The server computer of claim 11 further comprising:
applying a passive profile of rules to the plurality of transactions at the same time as applying the active profile of rules to the plurality of transactions; and
generating a passive profile report as a result of applying the passive profile.

14. The server computer of claim 13, wherein generating the passive profile report takes longer than generating the replay profile report.

15. The server computer of claim 11, wherein the replay profile report is generated in a tic-tac-toe format.

16. A client computer comprising a processor, and a computer readable medium coupled to the processor, the computer readable medium comprising code, executable by the processor for implementing a method comprising:
searching for a plurality of transactions;
selecting an active profile of rules;
selecting a replay profile of rules;
scheduling a replay of the plurality of transactions against the replay profile; and
receiving a replay profile report.

17. The client computer of claim 16, wherein the searching for the plurality of transactions is performed based on a transaction selection criterion.

18. The client computer of claim 16, wherein the selecting a replay profile is performed using a replay profile selector rule.

19. A method performed using a client computer, the method comprising:
searching for a plurality of transactions;
selecting an active profile of rules;
selecting a replay profile of rules;
scheduling a replay of the plurality of transactions against the replay profile; and
receiving a replay profile report.

20. The method of claim 19, wherein a rule from the replay profile of rules is moved to the active profile of rules based on the outcome of the replay.
